(19) United States
(12) Patent Application Publication
(10) Pub. No.: US 2017/0168379 A1
(43) Pub. Date: Jun. 15, 2017

(54) WAVELENGTH CONVERSION ELEMENT, ILLUMINATION DEVICE, PROJECTOR, AND METHOD OF MANUFACTURING WAVELENGTH CONVERSION ELEMENT

(71) Applicant: SEIKO EPSON CORPORATION, Tokyo (JP)

(72) Inventor: Toshiaki HASHIZUME, Okaya-shi (JP)

(73) Assignee: SEIKO EPSON CORPORATION, Tokyo (JP)

(21) Appl. No.: 15/370,378

(22) Filed: Dec. 6, 2016

(30) Foreign Application Priority Data
Dec. 14, 2015 (JP) 2015-243004

(51) Int. Cl. G03B 21/20; G02B 5/30; G02B 27/14; G02B 5/02; G02B 19/00; G02B 1/11; G03B 21/00; C04B 41/89; C04B 41/86; C04B 41/50; C09K 11/02; C09K 11/77; C03C 4/12; C03C 17/02; C03C 17/245; F21K 9/64

(52) U.S. Cl. CPC G03B 21/204; F21K 9/64; G02B 5/3083; G02B 27/141; G02B 5/021; G02B 19/0009; G02B 1/11; G03B 21/005; C04B 41/89; C04B 41/86; C04B 41/5022; C09K 11/025; C09K 11/7774; C03C 4/12; C03C 17/02; C03C 17/2456; F21Y 2115/30

(57) ABSTRACT

A wavelength conversion element according to the invention includes: a base material; a wavelength conversion layer supported by one surface of the base material and containing a wavelength conversion material and an inorganic binder; a light transmitting layer provided in a side of the wavelength conversion layer opposite to the base material and made of an inorganic material; and an antireflection film provided in a side of the light transmitting layer opposite to the wavelength conversion layer.

### BACKGROUND

1. Technical Field

The present invention relates to a wavelength conversion element, an illumination device, a projector, and a method of manufacturing a wavelength conversion element.

2. Related Art

In recent years, an illumination device using a phosphor has been proposed as an illumination device for a projector. In the illumination device, the phosphor is irradiated with excitation light to produce fluorescence in a wavelength range different from the excitation light, and thus illumination light including the fluorescence is generated. JP-A-2014-207436 discloses a wavelength converter including a phosphor layer containing glass as a binder and a phosphor, an antireflection film provided at least one surface of the phosphor layer, and a light transmitting substrate.

In manufacturing the wavelength converter, a phosphor material containing the phosphor and the glass mixed together is applied on the light transmitting substrate, and then, the phosphor material is sintered to form the phosphor layer. Thereafter, the antireflection film is formed on the one surface of the phosphor layer. However, the flatness of the surface of the phosphor layer is not sufficiently high, and therefore, the antireflection film has a problem of failing to provide a sufficient antireflection function when the antireflection film is directly formed on the phosphor layer.

### SUMMARY

An advantage of one aspect of the invention is to provide a wavelength conversion element including an antireflection film having a sufficient antireflection function, and a method of manufacturing the wavelength conversion element. Another advantage of one aspect of the invention is to provide an illumination device including a wavelength conversion element including an antireflection film having a sufficient antireflection function, and capable of emitting light of sufficient luminance. Still another advantage of one aspect of the invention is to provide a projector including an illumination device with excellent luminance, and capable of obtaining a bright image.

A wavelength conversion element according to one aspect of the invention includes: a base material; a wavelength conversion layer supported by one surface of the base material and containing a wavelength conversion material and an inorganic binder; a light transmitting layer provided in a side of the wavelength conversion layer opposite to the base material and made of an inorganic material; and an antireflection film provided in a side of the light transmitting layer opposite to the wavelength conversion layer.

In the wavelength conversion element according to the aspect of the invention, since the flatness of the surface of the wavelength conversion layer is enhanced by the light transmitting layer, the flatness of the antireflection film is high. Therefore, the antireflection film can provide a sufficient antireflection function.

An illumination device according to one aspect of the invention includes: a light source that emits first light in a first wavelength range; and the wavelength conversion element according to the aspect of the invention, on which the first light is incident and which emits second light in a second wavelength range different from the first wavelength range.

Since the illumination device according to the aspect of the invention includes the wavelength conversion element according to the aspect of the invention, light of sufficient luminance can be emitted.

In the illumination device according to the aspect of the invention, the antireflection film may have an antireflection action on both the first wavelength range and the second wavelength range.

According to this configuration, the antireflection function is provided for both the first light and the second light. With this configuration, light of higher luminance can be emitted.

A projector according to one aspect of the invention includes: the illumination device according to the aspect of the invention; a light modulator that modulates light emitted from the illumination device, in response to image information; and a projection optical system that projects the light modulated by the light modulator.

Since the projector according to the aspect of the invention includes the illumination device according to the aspect of the invention, a bright image can be displayed.

A method of manufacturing a wavelength conversion element according to one aspect of the invention includes: applying a first mixture containing a phosphor powder and a first glass powder to one surface of a base material; applying a second mixture containing a second glass powder on the first mixture applied to the base material; sintering the first mixture and the second mixture; and forming an antireflection film on the second mixture sintered.

The method of manufacturing a wavelength conversion element according to the aspect of the invention includes the applying of the first mixture containing the phosphor powder and the first glass powder, and the applying of the second mixture containing the second glass powder on the first mixture, and therefore, irregularities on the surface of a layer made of the first mixture are flattened by a layer made of the second mixture. With this configuration, since the flatness of the antireflection film is enhanced, the antireflection film can provide a sufficient antireflection function. Moreover, since the method of manufacturing a wavelength conversion element according to the aspect of the invention includes the sintering of the first mixture and the second mixture, sintering of the first mixture and the second mixture is accomplished at one time, and thus the manufacturing process is simplified.

A method of manufacturing a wavelength conversion element according to another aspect of the invention includes: applying a first mixture containing a phosphor powder and a first glass powder to one surface of a base material; sintering the first mixture; applying a second mixture containing a second glass powder on the first mixture sintered; sintering the second mixture; and forming an antireflection film on the second mixture sintered.

According to the method of manufacturing a wavelength conversion element according to the aspect of the invention, since the flatness of the antireflection film is high, the antireflection film can provide a sufficient antireflection function.

### BRIEF DESCRIPTION OF THE DRAWINGS

The invention will be described with reference to the accompanying drawings, wherein like numbers reference like elements.

FIG. 1 is a schematic configuration diagram of a projector of one embodiment of the invention.

FIG. 2 is a schematic configuration diagram of an illumination device of the embodiment of the invention.

FIG. 3 is a cross-sectional view of a wavelength conversion device.

### DESCRIPTION OF EXEMPLARY EMBODIMENTS

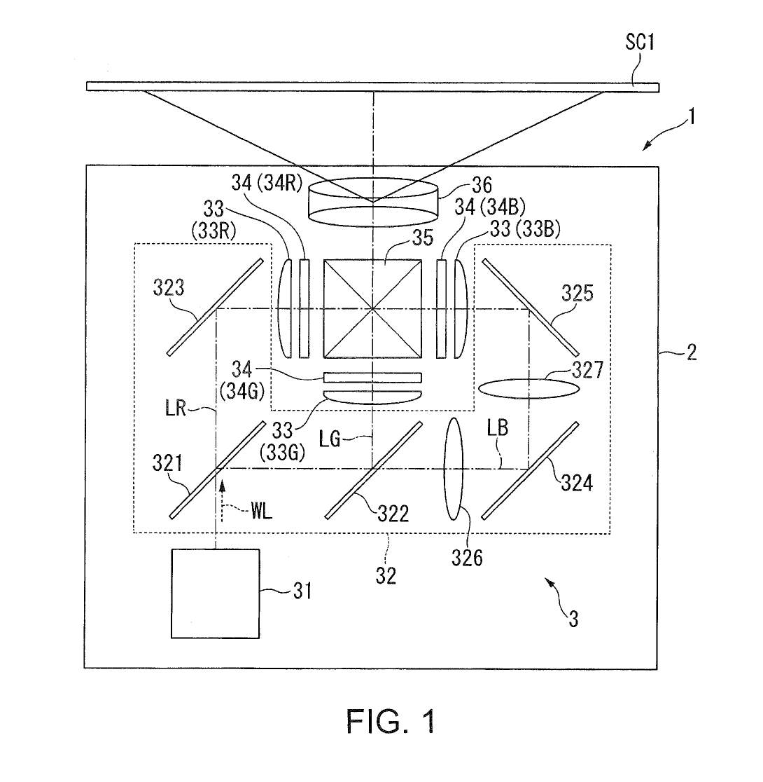

Hereinafter, one embodiment of the invention will be described with reference to FIGS. 1 to 3.

In the drawings below, components may be shown in different dimension scales for the sake of clarity of each of the components.

A projector 1 modulates a light beam emitted from a light source provided in the interior of the projector 1 to form an image in response to image information, and enlarges and projects the image onto a projected surface such as a screen SC1.

As shown in FIG. 1, the projector 1 includes an external housing 2 and an optical unit 3 accommodated in the external housing 2. In addition, although not shown in the drawing, the projector 1 includes a controller that controls the projector 1, a cooling device that cools an object to be cooled, and a power supply device that supplies power to electronic components constituting the projector 1.

### Configuration of Optical Unit

The optical unit 3 includes an illumination device 31, a color separating device 32, a collimating lens 33, alight modulator 34, a color combining device 35, and a projection optical system 36.

The illumination device 31 emits illumination light WL. The configuration of the illumination device 31 will be described later.

The color separating device 32 separates the illumination light WL incident from the illumination device 31 into three colored lights of red (R), green (G), and blue (B). The color separating device 32 includes a dichroic mirror 321, a dichroic mirror 322, a reflection mirror 323, a reflection mirror 324, a reflection mirror 325, a relay lens 326, and a relay lens 327.

The dichroic mirror 321 separates the illumination light WL from the illumination device 31 into red light LR and the other colored light (green light LG and blue light LB). The dichroic mirror 321 transmits the red light LR while reflecting the other colored light (the green light LG and the blue light LB). The dichroic mirror 322 separates the other colored light into the green light LG and the blue light LB. The dichroic mirror 322 reflects the green light LG while transmitting the blue light LB.

The reflection mirror 323 is disposed on the optical path of the red light LR, and reflects the red light LR transmitted through the dichroic mirror 321 toward a light modulator 34R. The reflection mirror 324 and the reflection mirror 325 are disposed on the optical path of the blue light LB, and guide the blue light LB transmitted through the dichroic mirror 322 to a light modulator 34B. The green light LG is reflected by the dichroic mirror 322 toward a light modulator 34G.

The relay lens 326 and the relay lens 327 are disposed at the rear stage of the dichroic mirror 322 on the optical path of the blue light LB. The relay lens 326 and the relay lens 327 compensate for light loss of the blue light LB due to the fact that the optical path length of the blue light LB is longer than the optical path lengths of the red light LR and the green light LG.

The collimating lens 33 collimates the light incident on the light modulator 34. Collimating lenses for the respective colored lights of red, green, and blue are referred to as a “collimating lens 33R”, a “collimating lens 33G”, and a “collimating lens 33B”. Light modulators for the respective colored lights of red, green, and blue are referred to as the “light modulator 34R”, the “light modulator 34G”, and the “light modulator 34B”.

The light modulator 34R, the light modulator 34G, and the light modulator 34B respectively modulate the red light LR, the green light LG, and the blue light LB incident thereon to form a color image in response to image information. The light modulator 34R, the light modulator 34G, and the light modulator 34B are each composed of a liquid crystal panel that modulates the incident light. Although not shown in the drawing, polarizers are disposed on the light incident and exiting sides of each of the light modulator 34R, the light modulator 34G, and the light modulator 34B.

Image lights from the light modulator 34R, the light modulator 34G, and the light modulator 34B are incident on the color combining device 35. The color combining device 35 combines the image lights corresponding to the red light LR, the green light LG, and the blue light LB, and emits the combined image light toward the projection optical system 36. The color combining device 35 is composed of, for example, a cross dichroic prism.

The projection optical system 36 projects the image light combined by the color combining device 35 onto the projected surface such as the screen SC1. With the configuration described above, an enlarged image is projected on the screen SC1. The projection optical system 36 is composed of, for example, a plurality of projection lenses.

### Illumination Device

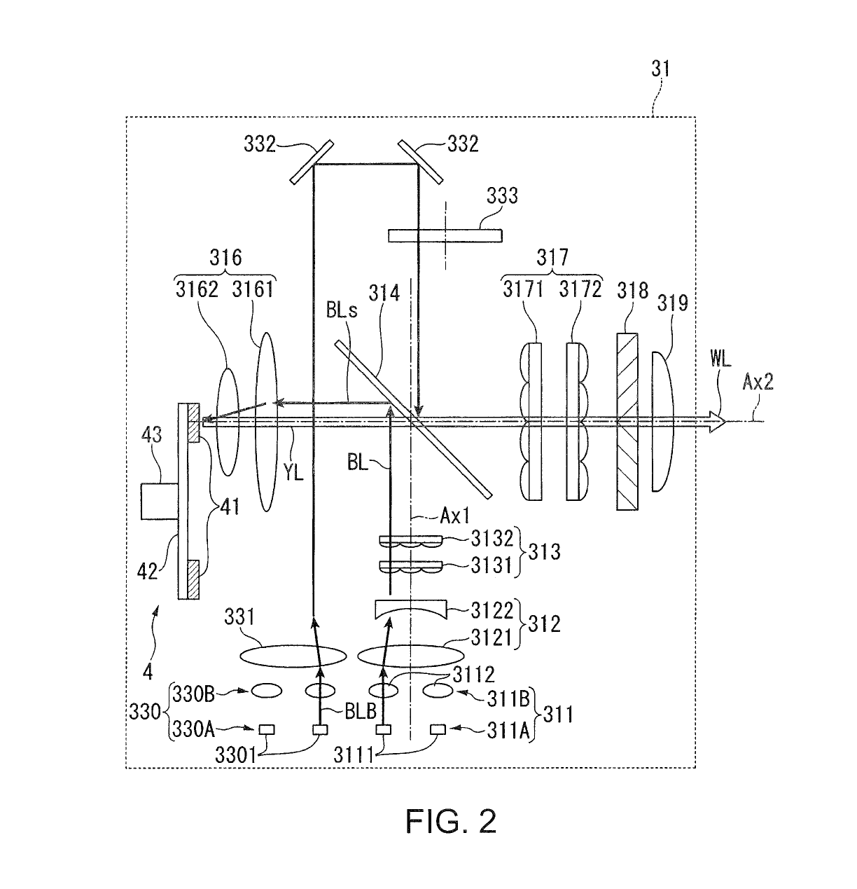

FIG. 2 is a schematic view showing the configuration of the illumination device 31 in the projector 1 of the embodiment.

The illumination device 31 emits the illumination light WL toward the color separating device 32. As shown in FIG. 2, the illumination device 31 includes a light source device 311 for excitation, an afocal optical system 312, a homogenizer optical system 313, a dichroic mirror 314, a pickup optical system 316, an integrator optical system 317, a polarization conversion element 318, a superimposing lens 319, a wavelength conversion device 4, a light source device 330 for blue, a condenser lens 331, reflectors 332, and a rotating diffuser 333. The light source device 311 for excitation includes an array light source 311A and a collimator optical system 311B. The light source device 330 for blue includes an array light source 330A and a collimator optical system 330B.

The array light source 311A of the embodiment corresponds to a light source in the appended claims.

The array light source 311A of the light source device 311 for excitation is composed of a plurality of semiconductor lasers 3111. Specifically, in the array light source 311A, the plurality of semiconductor lasers 3111 are arranged in an array in the plane orthogonal to an illumination optical axis Ax1 of the light beams emitted from the array light source 311A. When the optical axis of a principal ray of fluorescence YL emitted from the wavelength conversion device 4 is Ax2, the illumination optical axis Ax1 and the optical axis Ax2 lie in the same plane and are orthogonal to each other, which will be described in detail later. The array light source 311A, the collimator optical system 311B, the afocal optical system 312, the homogenizer optical system 313, and the dichroic mirror 314 are arranged in this order on the illumination optical axis Ax1.

The semiconductor laser 3111 constituting the array light source 311A emits excitation light (blue light BL) having a peak wavelength in a wavelength range of, for example, from 440 to 480 nm. The blue light BL emitted from the semiconductor laser 3111 is coherent linearly polarized light. The blue light BL is emitted parallel to the illumination optical axis Ax1 toward the dichroic mirror 314.

The array light source 311A is configured such that the blue light BL emitted by the semiconductor laser 3111 is incident as S-polarized light relative to the dichroic mirror 314. The blue light BL emitted from the array light source 311A is incident on the collimator optical system 311B.

In the embodiment, the excitation light (the blue light BL) in the wavelength range of from 440 to 480 nm emitted from the semiconductor laser 3111 corresponds to first light in a first wavelength range in the appended claims.

The collimator optical system 311B converts the blue light BL emitted from the array light source 311A to parallel light. The collimator optical system 311B includes a plurality of collimator lenses 3112 arranged in, for example, an array corresponding to the semiconductor lasers 3111. The blue light BL transmitted through the collimator optical system 311B and thus converted to the parallel light is incident on the afocal optical system 312.

The afocal optical system 312 adjusts the light beam diameter of the blue light BL incident from the collimator optical system 311B. The afocal optical system 312 includes a lens 3121 and a lens 3122. The blue light BL transmitted through the afocal optical system 312 and thus adjusted in size is incident on the homogenizer optical system 313.

The homogenizer optical system 313 makes the illuminance distribution of the blue light BL in the illuminated area uniform, together with the pickup optical system 316. The homogenizer optical system 313 includes a pair of multi-lens array 3131 and multi-lens array 3132. The blue light BL emitted from the homogenizer optical system 313 is incident on the dichroic mirror 314.

The dichroic mirror 314 has a polarization separation function to separate the blue light BL in the first wavelength range into an S-polarization component and a P-polarization component. The dichroic mirror 314 reflects the S-polarization component of the blue light BL and transmits the P-polarization component of the blue light BL. Hence, the blue light BL is reflected as S-polarized excitation light BLs toward the wavelength conversion device 4.

Moreover, the dichroic mirror 314 has a color separating function to transmit light in a second wavelength range (green light GL and red light RL) different from the first wavelength range (the wavelength range of the blue light BL), irrespective of the polarization state.

The pickup optical system 316 condenses the excitation light BLs onto a wavelength conversion element 41. The pickup optical system 316 includes a lens 3161 and a lens 3162. Specifically, the pickup optical system 316 condenses a plurality of light beams (the excitation light BLs) incident thereon onto the wavelength conversion element 41 described later while superimposing the plurality of light beams on each other on the wavelength conversion element 41.

The excitation light BLs from the pickup optical system 316 is incident on the wavelength conversion element 41. The wavelength conversion element 41 converts the excitation light BLs to the fluorescence YL including red light and green light, and emits the fluorescence YL. The fluorescence YL (yellow light) has a peak wavelength in a wavelength range of from 500 to 700 nm. The configuration of the wavelength conversion element 41 will be described later.

The fluorescence in the wavelength range of from 500 to 700 nm in the embodiment corresponds to second light in a second wavelength range in the appended claims.

The fluorescence YL emitted from the wavelength conversion device 4 passes through the pickup optical system 316 and is incident on the dichroic mirror 314.

The array light source 330A of the light source device 330 for blue is composed of a plurality of semiconductor lasers 3301. Specifically, the array light source 330A is arranged in the same direction as the array light source 311A. The array light source 330A, the collimator optical system 330B, the condenser lens 331, the two reflectors 332, and the rotating diffuser 333 are arranged in this order.

The semiconductor laser 3301 constituting the array light source 330A emits blue light BLB having a peak wavelength in the wavelength range of, for example, from 440 to 480 nm. The blue light BLB emitted from the semiconductor laser 3301 is coherent linearly polarized light. The blue light BLB is collimated by the collimator optical system 330B and then condensed by the condenser lens 331 into a certain area on the rotating diffuser 333.

The reflector 332 is a mirror that is disposed to change the angle of a ray of light. A plurality of microlenses with a size of approximately from several micrometers to several tens micrometers are disposed on the surface of the rotating diffuser 333. The rotating diffuser 333 is rotated by a motor (not shown). With this configuration, the blue light BLB emitted from the condenser lens 331 can be spread to a divergence angle of approximately from 30° to 60°. This is done for removing speckles of the semiconductor laser 3301. The blue light BLB is emitted from the rotating diffuser 333 toward the dichroic mirror 314.

The fluorescence YL and the blue light BLB are combined together by the dichroic mirror 314 to produce the illumination light WL of white. The illumination light WL is emitted from the dichroic mirror 314 and incident on the integrator optical system 317.

The integrator optical system 317 makes the illuminance distribution in the illuminated area uniform, together with the superimposing lens 319 described later. The integrator optical system 317 includes a pair of lens array 3171 and lens array 3172. The pair of lens array 3171 and lens array 3172 each have a configuration including a plurality of lenses arranged in an array. The illumination light WL emitted from the integrator optical system 317 is incident on the polarization conversion element 318.

The polarization conversion element 318 includes a polarization separation film and a retardation film. The polarization conversion element 318 converts the illumination light WL to linearly polarized light. The illumination light WL emitted from the polarization conversion element 318 is incident on the superimposing lens 319.

The superimposing lens 319 superimposes the illumination light WL in the illuminated area to thereby make the illuminance distribution in the illuminated area uniform.

### Wavelength Conversion Device

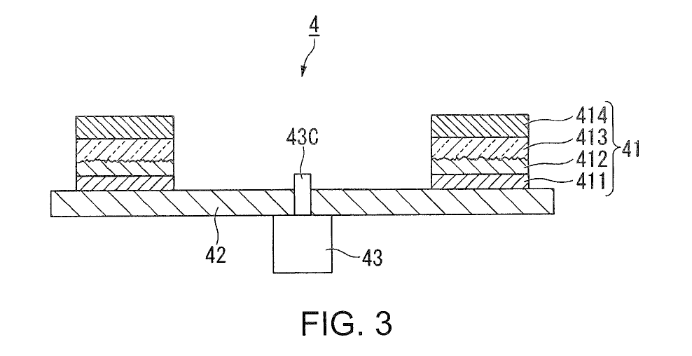

FIG. 3 is a cross-sectional view of the wavelength conversion device 4 including the wavelength conversion element 41.

As shown in FIG. 3, the wavelength conversion device 4 includes a heat dissipating plate 42, a motor 43, and the wavelength conversion element 41. The wavelength conversion element 41 includes a base material 411, a wavelength conversion layer 412, a light transmitting layer 413, and an antireflection film 414. For example, a layer for enhancing the adhesion between the base material 411 and the wavelength conversion layer 412 may be provided between the base material 411 and the wavelength conversion layer 412.

The heat dissipating plate 42 is composed of, for example, a plate body made of metal having a high thermal conductivity, such as aluminum. The motor 43 as a means of rotating the heat dissipating plate 42 is connected to the heat dissipating plate 42. The heat dissipating plate 42 of the embodiment has a circular plate shape. An axis 43C of rotation of the motor 43 is provided at the center of a circle that is the planar shape of the heat dissipating plate 42. The heat dissipating plate 42 rotates with the rotation of the motor 43. However, the planar shape of the heat dissipating plate 42 is not necessarily limited to be circular, and may be other shapes.

The base material 411 is composed of, for example, a sintered body containing a metal oxide such as aluminum oxide (Al₂O₃) or zirconium oxide (ZrO₂). Hence, the base material 411 contains a plurality of crystals of the metal oxide, and voids are provided between some adjacent crystals. The base material 411 has a characteristic that reflection and scattering of light are large because of the presence of voids at the grain boundaries of the metal oxide as described above. Therefore, the base material 411 functions as a reflective material. The base material 411, the wavelength conversion layer 412, the light transmitting layer 413, and the antireflection film 414 each have a circular ring shape along the circumferential direction of the heat dissipating plate 42.

The wavelength conversion layer 412 is provided on one surface of the base material 411. The wavelength conversion layer 412 contains a wavelength conversion material and an inorganic binder. The wavelength conversion material of the embodiment is a phosphor. The wavelength conversion layer 412 has a configuration in which the phosphor is dispersed within the inorganic binder. In the embodiment, a yttrium aluminum garnet (YAG) phosphor containing Ce ions is used as the phosphor. As the inorganic binder, for example, a tin phosphate-based glass, a borosilicate-based glass, a bismuth-based glass, or the like is used. Specifically, examples of the inorganic binder include a ZnO—B₂O₃—SiO₂-based glass, a R₂O (R: alkali metal)-PbO—SiO₂-based glass, a R₂O (R: alkali metal)-CaO—PbO—SiO₂-based glass, a BaO—Al₂O₃—B₂O₃—SiO₂-based glass, and a B₂O₃—SiO₂-based glass.

The light transmitting layer 413 is provided in a side of the wavelength conversion layer 412 opposite to the base material 411. The light transmitting layer 413 is made of, for example, an inorganic material such as glass. When the light transmitting layer 413 is made of glass, glass of the same kind as the glass constituting the inorganic binder of the wavelength conversion layer 412 is preferably used for the light transmitting layer 413. That is, for example, a tin phosphate-based glass, a borosilicate-based glass, a bismuth-based glass, or the like is preferably used for the light transmitting layer 413. However, glass different from the glass constituting the inorganic binder of the wavelength conversion layer 412 may be used as the light transmitting layer 413.

The antireflection film 414 is provided in a side of the light transmitting layer 413 opposite to the wavelength conversion layer 412. The antireflection film 414 is composed of, for example, a dielectric multilayer film. Specifically, the antireflection film 414 is composed of stacked films including three silicon oxide films and three titanium oxide films alternately stacked on each other. When the antireflection film 414 is composed of a dielectric multilayer film, the wavelength range for which an antireflection function is provided can be adjusted by changing the thickness of each of the films constituting the dielectric multilayer film, the number of layers, and the like.

The antireflection film 414 preferably has the antireflection function for both the excitation light (blue light) in the wavelength range of from 440 to 480 nm and the fluorescence (yellow light) in the wavelength range of from 500 to 700 nm.

Hereinafter, a method of manufacturing the wavelength conversion element 41 will be described.

A binder, a plasticizer, an organic solvent, and the like are added to a metal oxide powder, for example an Al₂O₃ powder, constituting the base material 411, and then, the resultant is stirred and mixed to prepare a slurry for forming the base material.

Next, the slurry is formed into a sheet, and then, punching out is performed by press working to produce a green molded article having a predetermined shape (for example, a circular ring shape). Next, the green molded article is sintered to thereby produce the base material 411 made of the sintered body containing the metal oxide.

Next, a first mixture containing a phosphor powder and a first glass powder is applied to one surface of the base material 411. In this step, the first mixture obtained by mixing the phosphor powder having a particle diameter of several micrometers, the glass powder having a particle diameter equal to or less than the particle diameter of the phosphor powder, and an organic substance together is produced, and the first mixture is applied to one surface of the base material 411. As described above, the powder of the YAG phosphor containing Ce ions is used as the phosphor powder. As the first glass powder, for example, the powder of a tin phosphate-based glass, a borosilicate-based glass, a bismuth-based glass, or the like is used. The organic substance functions as an adhesive that binds the powders together.

Next, a second mixture containing a second glass powder is applied on the first mixture applied to the base material 411. In this step, the second mixture obtained by mixing the glass powder having a particle diameter of several micrometers and an organic substance together is produced, and the second mixture is applied over the first mixture. A glass powder of the same kind as the first glass powder is preferably used as the second glass powder. Alternatively, a glass powder different from the first glass powder may be used as the second glass powder, in which case a glass powder having a melting point approximately the same as the first glass powder is preferably used.

Next, the base material 411 on which the first mixture and the second mixture are applied is heated to sinter the first mixture and the second mixture. In this step, sintering is performed at a temperature of several hundreds degrees Celsius, which is the melting point of the glass powder. The organic substance evaporates in the sintering at this temperature. Through this step, the wavelength conversion layer 412 containing the phosphor and the glass mixed together is formed on the one surface of the base material 411, and further, the light transmitting layer 413 made of glass is formed on the wavelength conversion layer 412.

Next, the antireflection film 414 is formed on the first and second mixtures sintered. In this step, a dielectric multilayer film including silicon oxide films and titanium oxide films alternately stacked on each other is formed using a deposition method such as an evaporation method or a sputtering method, and is used as the antireflection film 414.

Through the steps described above, the wavelength conversion element 41 of the embodiment is produced.

The present inventor has found that a wavelength conversion element in the related art including the antireflection film directly formed on the wavelength conversion layer failed to obtain desired wavelength conversion efficiency because the surface of the wavelength conversion layer is rough and the antireflection film is not uniformly formed. It is considered that, for example, when the wavelength conversion layer obtained by sintering a phosphor powder and a glass powder is formed, the particles of the phosphor powder are present in the vicinity of the surface of the wavelength conversion layer, irregularities reflecting the particle shape are formed on the surface of the wavelength conversion layer, and therefore, the surface of the wavelength conversion layer becomes rough.

For improving the problem, the flatness of the surface of the wavelength conversion layer 412 is enhanced by the light transmitting layer 413 in the wavelength conversion element 41 of the embodiment, and therefore, the flatness of the antireflection film 414 is high. Hence, the antireflection film 414 can provide a sufficiently high antireflection function.

Particularly the antireflection film 414 of the embodiment has the antireflection function for both the excitation light and the fluorescence. Therefore, when the excitation light is incident on the wavelength conversion layer 412, less excitation light is reflected at the surface of the wavelength conversion layer 412, and thus the amount of excitation light reaching the wavelength conversion layer 412 is large compared with that of the related art. Further, when the fluorescence is emitted from the wavelength conversion layer 412, less fluorescence is reflected at the surface of the wavelength conversion layer 412, and thus the amount of fluorescence emitted from the wavelength conversion layer 412 is large compared with that of the related art. As a result, according to the embodiment, the wavelength conversion element 41 capable of emitting a larger amount of fluorescence than that of the related art can be obtained.

Moreover, in the method of manufacturing the wavelength conversion element 41 of the embodiment, glass powders of the same kind or glass powders having melting points approximately the same as each other are used as the glass powder for the wavelength conversion layer and the glass powder for the light transmitting layer. Therefore, after the first mixture and the second mixture are successively applied on the base material 411, the first mixture and the second mixture can be collectively sintered. Therefore, sintering of the first mixture and the second mixture is accomplished at one time, and thus the manufacturing process is simplified.

In addition to the above manufacturing method, the following manufacturing method may be employed.

When sintering is performed after the first mixture is applied to the base material, the organic substance in the first mixture can be evaporated and also the glass itself can be melted. In the wavelength conversion layer 412 formed in this manner, the degree of flatness of the surface of the glass itself is high, but a portion of crystals of the phosphor projects from the surface. Therefore, the flatness of the surface of the wavelength conversion layer 412 is not so high.

Next, the second mixture is applied to the surface of the wavelength conversion layer 412, and the wavelength conversion layer 412 is sintered again to form the light transmitting layer 413. With this configuration, since the projected portion of crystals of the phosphor is covered by the light transmitting layer 413, sufficiently high flatness is obtained.

Finally, the antireflection film 414 is formed on the light transmitting layer 413.

Also by the manufacturing method described above, the wavelength conversion element 41 including the antireflection film 414 having a sufficient antireflection function can be manufactured.

The technical scope of the invention is not limited to the embodiment, but various modifications can be added within the range not departing from the gist of the invention.

For example, in the embodiment, an example of the wavelength conversion element having the form in which excitation light enters from one surface side of the base material and fluorescence is emitted from the surface on which the excitation light is incident, a so-called reflective wavelength conversion element, has been mentioned. Instead of this form, the invention can be applied also to a wavelength conversion element including a light-transmissive base material not including a reflective member, a so-called transmissive wavelength conversion element.

In addition, the shape, number, arrangement, material, and the like of the various components of the wavelength conversion element, the illumination device, and the projector are not limited to those of the embodiment and can be appropriately modified. Moreover, although an example in which the illumination device according to the invention is mounted in the projector using a liquid crystal light valve has been shown in the embodiment, the invention is not limited to this example. The illumination device may be mounted in a projector using a digital micromirror device as a light modulator.

Although an example in which the illumination device according to the invention is mounted in the projector has been shown in the embodiment, the invention is not limited to this example. The illumination device according to the invention can be applied also to a luminaire, a headlight of an automobile, or the like.

Although an example of the wavelength conversion element using a phosphor has been mentioned as a wavelength conversion element, the invention is not limited to this example. A wavelength conversion element using, for example, a compound semiconductor such as GaN or GaAs may be employed as a wavelength conversion element.

The entire disclosure of Japanese Patent Application No. 2015-243004, filed on Dec. 14, 2015 is expressly incorporated by reference herein.

What is claimed is:

1. A wavelength conversion element comprising:
a base material;
a wavelength conversion layer supported by one surface of the base material and containing a wavelength conversion material and an inorganic binder;
a light transmitting layer provided in a side of the wavelength conversion layer opposite to the base material and made of an inorganic material; and
an antireflection film provided in a side of the light transmitting layer opposite to the wavelength conversion layer.

2. An illumination device comprising:
a light source that emits first light in a first wavelength range; and
the wavelength conversion element according to claim 1, on which the first light is incident and which emits second light in a second wavelength range different from the first wavelength range.

3. The illumination device according to claim 2, wherein
the antireflection film has an antireflection action on both the first wavelength range and the second wavelength range.

4. A projector comprising:
the illumination device according to claim 2;
a light modulator that modulates light emitted from the illumination device, in response to image information; and
a projection optical system that projects the light modulated by the light modulator.

5. A method of manufacturing a wavelength conversion element, comprising:
applying a first mixture containing a phosphor powder and a first glass powder to one surface of a base material;
applying a second mixture containing a second glass powder on the first mixture applied to the base material;
sintering the first mixture and the second mixture; and
forming an antireflection film on the second mixture sintered.

6. A method of manufacturing a wavelength conversion element, comprising:
applying a first mixture containing a phosphor powder and a first glass powder to one surface of a base material;
sintering the first mixture;
applying a second mixture containing a second glass powder on the first mixture sintered;
sintering the second mixture; and
forming an antireflection film on the second mixture sintered.
